(19) United States
(12) Patent Application Publication
(10) Pub. No.: US 2022/0026534 A1
(43) Pub. Date: Jan. 27, 2022

(54) LIDAR SENSOR SYSTEM HAVING IMPROVED SURFACE QUALITY

(71) Applicant: COVESTRO INTELLECTUAL PROPERTY GMBH & CO. KG, Leverkusen (DE)

(72) Inventors: Alexander MEYER, Düsseldorf (DE); Rafael OSER, Krefeld (DE); Timo KUHLMANN, Leichlingen (DE); Peter CAPELLEN, Krefeld (DE)

(21) Appl. No.: 17/298,543

(22) PCT Filed: Nov. 14, 2019
(86) PCT No.: PCT/EP2019/081256

§ 371 Date: May 29, 2021

(30) Foreign Application Priority Data
Nov. 29, 2018 (EP) 18209035.7

(51) Int. Cl. G01S 7/481; C08K 5/101; G01S 17/86; G01S 17/931

(52) U.S. Cl. CPC G01S 7/4813; G01S 17/931; G01S 17/86; C08K 5/101

(57) ABSTRACT

A sensor system comprises a LiDAR unit having an emitter for laser light having a wavelength of 800 nm to 1600 nm and a receiver for light having a wavelength of 800 nm to 1600 nm and a cover arranged such that IR light emitted by the LiDAR unit and received thereby passes through the cover. The cover comprises a layer of a thermoplastic material, wherein the thermoplastic material contains a transparent thermoplastic polymer and a monoester of a monocarboxylic acid having ≥15 carbon atoms and glycerol or a monoalcohol having ≥15 carbon atoms. Furthermore, the thermoplastic material is free from mono-, di-, tri- and tetraesters of stearic acid and pentaerythritol.

The present invention relates to a sensor system comprising a LiDAR unit having an emitter for laser light having a wavelength of 800 nm to 1600 nm and a receiver for light having a wavelength of 800 nm to 1600 nm and a cover arranged such that IR light emitted by the LiDAR unit and received thereby passes through the cover. The invention also relates to a production process for such a system, to a vehicle which comprises such a sensor system and to the use of a thermoplastic material for producing covers for LiDAR sensors and/or LiDAR receivers.

Driver assistance systems such as emergency brake assistants, lane assistance systems, traffic sign recognition systems, adaptive speed control systems and distance controllers are known and are employed in current vehicles. To implement the recited functions, surroundings detection sensors generally based on radar, LiDAR, ultrasound and camera sensors are employed. Stereo-optical camera systems and LiDAR sensors are important in particular for highly automated and autonomous driving, since they are capable of providing high-resolution three-dimensional images of the vehicle surroundings at from close to distant range. The substrate materials described in the present invention are suitable in particular for optical camera systems such as mono and stereo camera systems and LiDAR sensors. The substrate materials are also suitable for radar sensors.

Optical camera systems are nowadays already employed in the field of vehicle sensors, for example for lane keeping assistants. A great advantage of optical sensors is that they can reproduce a very precise image of the environment, i.e. the environment is not detected point by point but rather large surface areas are imaged. If the distance, for example from an object or other vehicle located in front of the vehicle, is also to be determined, a plurality of cameras such as stereo cameras are employed instead of mono cameras. It is also possible to employ two or more LiDAR sensors instead of a rotating LiDAR system. Detecting at least two images makes it possible to calculate a three-dimensional image, for example by triangulation. Such a process thus also allows distance measurements. While systems for optical distance measurement are very precise, precision decreases with the distance from the particular object. When used as a sole sensor system, an optical camera system is dependent on the prevailing light conditions. Particular light conditions such as oncoming lights, strong sunlight, twilight or darkness can be severely detrimental to the measured result. Detecting objects showing little contrast or few contours can also be problematic. This can result in an erroneous interpretation of the environment.

A plurality of sensor systems are therefore employed. Accordingly, digital camera images may be compared with the information from other sensor systems such as radar and especially LiDAR sensors. The collated information allows the software to generate a very largely error-free image of the environment and correct any false readings from individual sensor systems. Generating such a precise image of the environment is indispensable for autonomous driving systems. A cover made of a thermoplastic material must therefore simultaneously be suitable for a plurality of sensor types and it is especially desirable for design reasons not to have to employ a plurality of materials but rather to be able to realize the particular cover from one material.

LiDAR (short for light detection and ranging) or else LaDAR (laser detection and ranging) is a method for optical distance and velocity measurement that is related to radar. Instead of radio waves or microwaves in the case of radar, it uses infrared laser beams. There are very different types of LiDAR systems, which differ inter alia in the horizontal detection range (e.g. 70° up to 360°), the type of laser (e.g. continuous-wave scanner laser or static pulsed laser) and the sensor technology (e.g. mechanically rotating mirror or semiconductor electronics). The present invention also covers infrared cameras related technically to LiDAR that use their own infrared light source.

Component parts based on thermoplastic material offer many advantages over conventional materials such as for example glass for use in the automotive sector. These include for example elevated fracture resistance and/or weight reduction which in the case of automobiles allow greater occupant safety in road traffic accidents and lower fuel consumption. Finally, materials containing thermoplastic polymers allow substantially greater freedom in design on account of their easier moldability.

A cover made of a thermoplastic material is intended to hide the LiDAR sensor and any optical camera system that may be present and also to provide protection for the sensitive sensor electronics.

LiDAR sensors and the use of the polycarbonate Makrolon 2405 with the color formulation 450601 are described in US 2012/0287417 A1. Further polycarbonate applications or compositions that relate to lidar sensors are described in WO 2018/197398 A1.

Polycarbonate compositions with glycerol esters or long-chain carboxylic acid esters but without pentaerythritol esters have already been described in the prior art. Thus, WO 2010/090893 A1 discloses in the experimental part on page 28 how polycarbonate pellets are sprayed with 400 ppm of Loxiol 3820 before addition of pulverulent additives and extrusion.

US 2011/0129631 A1 discloses in the experimental part in table 1 polycarbonate compositions containing inter alia Loxiol 3820 as mold release agent “MRA-1”. This publication identifies Loxiol 3820 as octyldodecyl stearate.

EP 2 810 978 A1 describes in example 2, paragraph [0049], that the polycarbonate Makrolon 2600 is extruded together with a mixture of carbon nanotubes (Baytubes C 150 P) and 2-octyl docecyl stearate (Loxiol 3820).

EP 0 732 360 A1 discloses in the experimental part in tables 1, 3 and 5 polycarbonate compositions comprising Loxiol EP 218 (“E1”, glycerol stearate), Loxiol EP 12 (“E2”, glycerol monostearate), Loxiol EP 32 (“E3”, ester of C₁₆-alcohol and stearic acid) and Loxiol EP 47 (“E4” ester of a C₁₆-alcohol and behenic acid).

EP 0 205 192 A1 describes in the experimental part in table 1 polycarbonate compositions comprising Resistat AF-101 (“B1”, partial ester of C₁₈-C₂₂-monobasic fatty acids and glycerol) and Rickemal S-100A (“B2”, stearyl monoglyceride).

The present invention has for its object to provide a sensor system whose cover exhibits reduced attenuation of the LiDAR signal. The cover should have good demolding properties, especially if the field of application is two- or three-dimensional cover panels for LiDAR sensors. If the demolding properties are insufficient, adhesion or sticking of the molded part may lead to surface defects which in turn attenuate the LiDAR signal. Since the quality requirements in the sensor sector are very high, such defects should be avoided.

The object is achieved in accordance with the invention by a sensor system according to claim 1 and a vehicle according to claim 13. The invention likewise relates to a process according to claim 11 and a use according to claim 14. Advantageous further developments are specified in the dependent claims. They may be combined as desired unless the opposite is clear from the context.

The sensor system comprises:
a LiDAR unit having an emitter for laser light having a wavelength of 800 nm to 1600 nm and a receiver for light having a wavelength of 800 nm to 1600 nm;
a cover arranged such that IR light emitted by the LiDAR unit and received thereby passes through the cover.

The cover comprises a layer of a thermoplastic material, wherein the thermoplastic material contains a transparent thermoplastic polymer and a monoester of a monocarboxylic acid having ≥15 carbon atoms and glycerol or a monoalcohol having ≥15 carbon atoms.

Also in effect is the proviso that the thermoplastic material is free from mono-, di-, tri- and tetraesters of stearic acid and pentaerythritol.

It has surprisingly been found that replacement of the customary pentaerythritol-based demolding agents, in particular PETS, by the abovementioned monoesters makes it possible to simultaneously achieve good demolding behavior in injection molding and superior surface quality, i.e. reduced attenuation of the LiDAR signal.

The term “free from” is to be understood as meaning in particular that no mono-, di-, tri- or tetraesters of stearic acid and pentaerythritol were deliberately added. Unwanted but technically unavoidable traces/impurities are accordingly included in the term “free from”.

It is preferable when the thermoplastic material is generally free from mono-, di-, tri- and tetraesters of pentaerythritol.

The cover is preferably a molded part employed in the front or rear region of a vehicle, for example a bumper, radiator grille, front panel or a rear panel, in particular a front panel for a motor vehicle, but may likewise be a vehicle side element. However, the cover may likewise also be a roof or roof module for a motor vehicle.

The cover may equally be a molded part employed in the interior of a vehicle. The system according to the invention may then be used to discern control gestures made by occupants of a vehicle.

The cover may be produced by injection molding. Furthermore, polycarbonate in particular also exhibits very good properties such as high heat resistance and high stiffness.

The distance between the cover and the LiDAR unit may be in the range from 1 cm to 20 cm for example.

The term “system” is used not only in the narrow sense of a package of mechanically joined individual parts, such as an apparatus, for instance, but also more broadly as a mere combination of individual parts (merely) joined in a functional sense to form a unit. The LiDAR emitter and receiver may be installed into the respective vehicle separately and the cover provided for a desired position in the vehicle through which the pulses of the LiDAR sensor are intended to pass. However, a mechanically joined combination may likewise be concerned.

The LiDAR unit comprises an emitter for laser light having a wavelength of 800 nm to 1600 nm. In accordance with the nature of laser light, this is not to be understood as meaning that the emitter emits light having every wavelength between 800 nm and 1600 nm. On the contrary, it is sufficient when light of one wavelength, for example 905 nm, is emitted. It is also possible to employ a plurality of lasers having different wavelengths in the recited range.

The receiver is typically narrowbandedly matched to the emitted laser light, for example 903 nm or 905 nm. It is also possible for the receiver to be matched to a broader spectral window in the wavelength range of 800 nm to 1600 nm or narrowbandedly to a plurality of wavelengths.

The thermoplastic material contains a transparent thermoplastic polymer. In the context of the present invention, “transparent” is to be understood as meaning that the plastic has a light transmission (based on ASTM 1003 or ISO 13468; specified in % and illuminant D65/100) of at least 6%, more preferably of at least 12%, and particularly preferably of at least 23%. Haze (ASTM D1003: 2013) is moreover preferably less than 3%, more preferably less than 2.5%, and particularly preferably less than 2.0%.

Examples of suitable thermoplastics are polycarbonate including copolycarbonate, polyester carbonate, polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), polyamide, cyclic polyolefin, poly- or copolyacrylates and poly- or copolymethacrylate such as for example poly- or copolymethyl methacrylates (such as PMMA) and copolymers comprising styrene such as for example transparent polystyrene acrylonitrile (PSAN), thermoplastic polyurethanes, polymers based on cyclic olefins (for example TOPAS®, a commercial product from Ticona). Here and elsewhere a reference to “polycarbonate” is preferably to be understood as meaning aromatic polycarbonate.

The thermoplastic material may also contain customary additives such as flame retardants, antistats, UV absorbers, stabilizers and antioxidants. Suitable ultraviolet absorbers are benzotriazoles, triazines, benzophenones and/or arylated cyanoacrylates. Preferred stabilizers include phosphites and phosphonites and also phosphines. It is also possible to employ alkyl phosphates, for example mono-, di- and trihexyl phosphate, triisooctyl phosphate and trinonyl phosphate. Employable antioxidants include phenolic antioxidants such as alkylated monophenols, alkylated thioalkylphenols, hydroquinones and alkylated hydroquinones.

The thermoplastic material preferably contains less than 0.1% by weight of, and very particularly preferably the compositions of the substrate layer are free from, scattering additives, for example such additives based on acrylate, polyethylene, polypropylene, polystyrene, glass, aluminum oxide and/or silicon dioxide. Furthermore, the composition particularly preferably contains less than 0.1% by weight of, and very particularly preferably is free from, white pigments or similar pigments such as, for example, titanium dioxide, kaolin, barium sulfate, zinc sulfide, aluminum oxide, aluminum hydroxide, quartz flour, from interference pigments and/or pearlescent pigments, i.e. platelet-shaped particles such as mica, graphite, talc, SiO₂, chalk and/or titanium dioxide, coated and/or uncoated.

Furthermore, the thermoplastic material preferably contains less than 0.1% by weight of, and very particularly preferably the composition is free from, nanoparticulate systems such as metal particles, metal oxide particles. The composition preferably also contains less than 0.1% by weight of, and particularly preferably is free from, pigments based on insoluble pigments, such as are described for example in DE 10057165 A1 and in WO 2007/135032 A2.

It is moreover advantageous for the thermoplastic material to contain 0 to ≤0.0005% by weight based on the total weight of the composition of infrared absorbers. It is preferable when the composition is free from infrared absorbers. This is related to the attenuation of the LiDAR signal by infrared absorbers in the polymer. Infrared absorbers are in particular carbon black, LaB₆ and molecules having a quaterylene structure.

Particularly suitable monoesters are glycerol monostearate and/or 2-octyldodecyl stearate.

The thermoplastic material preferably contains no further monoesters in addition to those of a monocarboxylic acid having ≥15 carbon atoms and glycerol or a monoalcohol having ≥15 carbon atoms. In a further embodiment the monoester is present in a proportion of ≥0.01% by weight to ≤0.6% by weight based on the total weight of the thermoplastic material in the described layer of the cover. It is more preferable when corresponding glycerol monoesters (for example glycerol monostearate) are present in proportions of ≥0.01% by weight to ≤0.06% by weight and/or corresponding monoesters of a monocarboxylic acid and a monoalcohol having ≥15 carbon atoms, for example 2-octyldodecyl stearate, are present in proportions of ≥0.15% by weight to ≤0.6% by weight.

In a further embodiment the thermoplastic polymer is a polycarbonate. This includes polycarbonate and copolycarbonate. Thus the polycarbonate may be an aromatic polycarbonate having a melt volume rate MVR of 8 to 20 cm³/(10 min) determined according to ISO 1133-1:2012-03 (300° C., 1.2 kg).

It is particularly preferable when the thermoplastic material contains only aromatic polycarbonate as the thermoplastic polymer.

Aromatic polycarbonates particularly preferred according to the invention as component i) preferably have weight-average molecular weights Mw of 22 000 to 29 000 g/mol, though in principle weight-average molecular weights Mw of 10 000 to 50 000 g/mol, more preferably of 14 000 to 40 000 g/mol, particularly preferably of 16 000 to 32 000 g/mol would also be suitable. The values Mw are determined here by gel permeation chromatography calibrated against bisphenol A polycarbonate standards using dichloromethane as eluent. The polycarbonates are preferably prepared by reactions of bisphenol compounds with carbonic acid compounds, especially phosgene, or with diphenyl carbonate or dimethyl carbonate in the melt transesterification process.

Particular preference is given here to homopolycarbonates based on bisphenol A and copolycarbonates based on the monomers bisphenol A and 1,1-bis(4-hydroxyphenyl)-3,3,5-trimethylcyclohexane, for example Apec® from Covestro Deutschland AG.

In a further embodiment the cover attenuates the LiDAR signal only to the extent that the signal intensity of the IR light emitted by the LiDAR unit and re-received thereby (determined by reflection from a smooth surface painted with TiO₂-containing white paint at a distance of 3.2 m) is ≥80% of a reference intensity determined without the cover.

In a further embodiment the thermoplastic material has a coefficient of static friction, determined as described in EP 1 377 812 B1, of ≤0.37. Preferred coefficients of sliding friction, also determined as described in EP 1 377 812 B1, are ≤0.37.

In a further embodiment the system further comprises a camera for visible light having a wavelength of 380 nm to 780 nm, wherein visible light received by the camera passes through the cover. The camera records light in the wavelength range from 380 nm to 780 nm, where this wavelength range is not to be understood as exhaustive. It is possible for this wavelength range to be broader, for example up to 800 nm, 900 nm, 1000 nm or 1100 nm. Cameras for visible light often have a preceding IR filter. If said filter is removed, several models can record images in the wavelength range of up to 1100 nm. In a further embodiment the camera therefore has a limited infrared filter, if any.

The camera is preferably a video camera in order to be able to provide the driver assistance system or autonomous driving system of the vehicle with information ideally in real time. The camera is more preferably a stereo camera.

In a further embodiment the cover further comprises a layer containing dyes and/or the thermoplastic material contains colorants, so that the cover has a light transmission Ty in the range from 380 to 780 nm of ≥3% to ≤25% determined according to DIN ISO 13468-2:2006 (D65, 10°) and the colorants are at least one green and/or one blue colorant and at least one red and/or violet colorant.

This configuration has the result that the cover appears to the observer to be dark to black and electronic elements arranged behind said cover such as sensors or cameras are hardly perceived, if at all. This is known as the “black panel” effect and allows the automotive designer greater freedom in the design of aesthetically pleasing automotive exteriors. The colorants are preferably colorants showing little or no absorption in the infrared range and in particular in the wavelength range of the LiDAR laser(s).

The cover preferably has a transmission for light in the range from 380 nm to 1100 nm of ≥40% determined according to DIN ISO 13468-2:2006 (based on this standard, the specified wavelength range was used).

The specified transmissions are to be understood as meaning average transmissions (arithmetic average) averaged over all wavelengths in the relevant range.

In one embodiment the green/blue colorant is selected from the formulae (1), (2a-c), (3), (4a), (4b), (5), (6), (7) and/or (8) and the read/violett colorant is selected from the formulae (9), (10), (11), (12), (13), (14a), (14b) and/or (15):

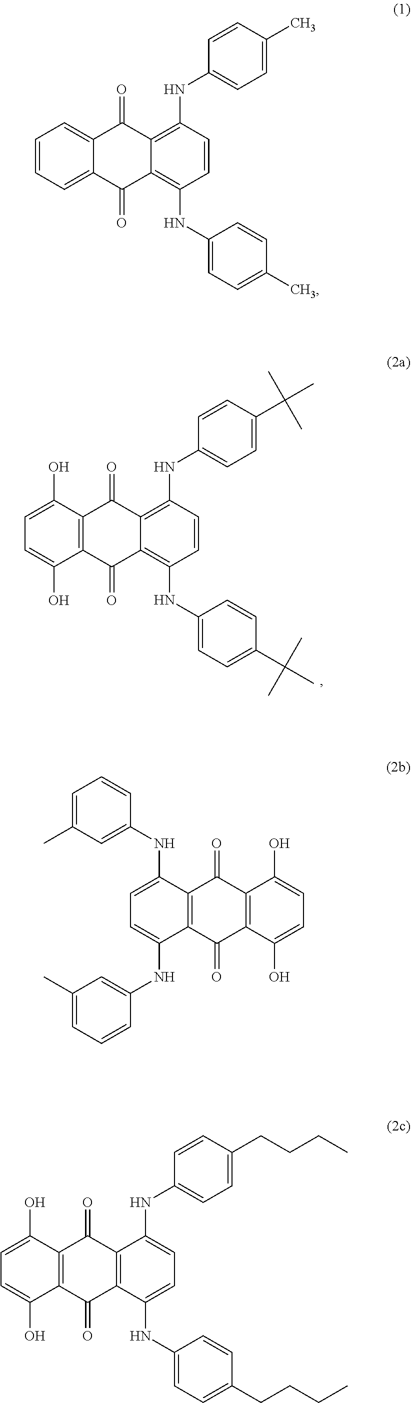

The colorant of formula (1) is known under the name Macrolex Green 5B from Lanxess Deutschland GmbH, Color Index number 61565, CAS Number: 128-90-3, and is an anthraquinone dye.

Colorants of formulae (2a), (2b) and (2c) are known inter alia under the name Macrolex Green G (Solvent Green 28).

Blue colorants employed according to this embodiment are colorants of formulae (3) and/or (4a/4b) and/or (5a/5b):

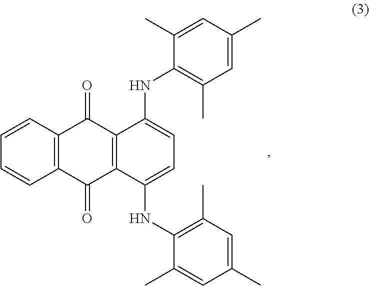 [SMILES: Cc1cc(C)c(Nc2ccc(Nc3c(C)cc(C)cc3C)c3c2C(=O)c2ccccc2C3=O)c(C)c1]

available under the name “Keyplast Blue KR”, CAS Number 116-75-6,

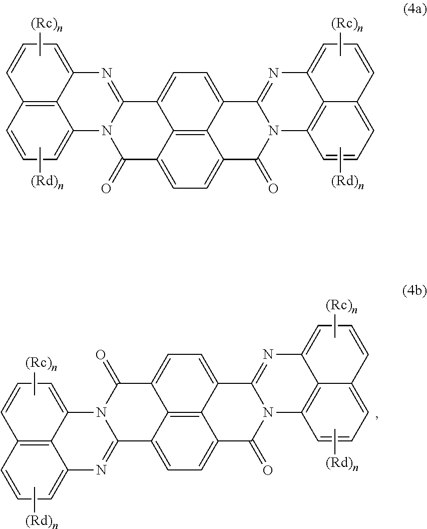

wherein
Rc and Rd independently of one another represent a linear or branched alkyl radical or halogen, preferably methyl, ethyl, propyl, isopropyl, butyl, isobutyl, tert-butyl, pentyl, neopentyl, hexyl, thexyl or Cl, more preferably methyl, Cl and especially preferably Cl,
n independently of the respective R represents a natural number between 0 and 3, wherein the radical is hydrogen for n=0.

In a preferred embodiment Rc and/or Rd are Cl and are in o- and/or p-positions relative to the carbon atoms bearing the amine functionalities, for example di-orthochloronaphthalino, di-ortho, mono-para-chloronaphthalino and mono-ortho-naphthalino. Furthermore, in a preferred embodiment Rc and Rd each represent a tert-butyl radical which is preferably in the meta position relative to the carbon atoms bearing the nitrogen functionalities.

In a particularly preferred embodiment n=0 in all rings, and so all Rc and Rd=H.

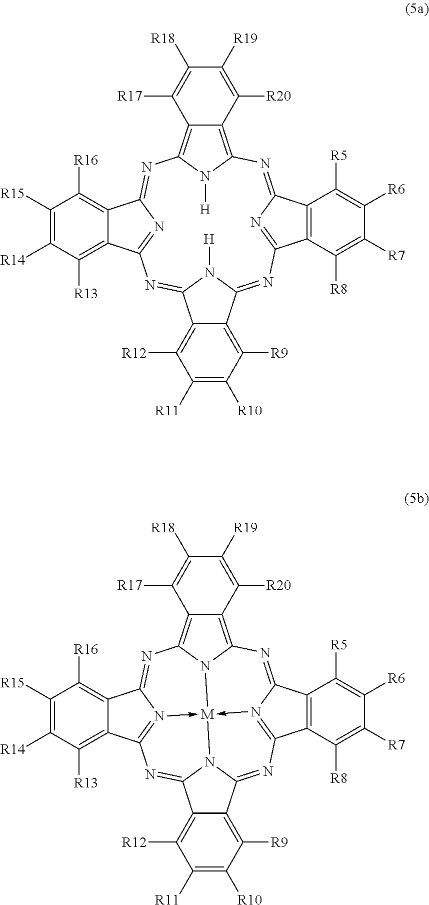

The radicals R(5-20) are each independently of one another hydrogen, methyl, ethyl, propyl, isopropyl, butyl, isobutyl, tert-butyl, pentyl, neopentyl, hexyl, thexyl, fluorine, chlorine, bromine, sulfone, CN.

R(5-20) is preferably identical in all positions. More preferably R(5-20) is H in all positions. In an alternative embodiment R(5-20) is Cl in all positions.

M is preferably aluminum (with R═H: Aluminum phthalocyanine, CAS: 14154-42-8), nickel (with R═H: nickel phthalocyanine, CAS: 14055-02-8), cobalt (with R═H: cobalt phthalocyanine, CAS: 3317-67-7), iron (with R═H: iron phthalocyanine, CAS: 132-16-1), zinc (with R═H: zinc phthalocyanine, CAS: 14320-04-08), copper (with R═H: copper phthalocyanine, CAS: 147-14-8; with R═H and Cl: polychlorocopper phthalocyanine, CAS: 1328-53-6; with R═Cl: hexadecachlorophthalocyanine, CAS: 28888-81-5; with R═Br: hexadecabromophthalocyanine, CAS: 28746-04-5), manganese (with R═H: manganese phthalocyanine, CAS: 14325-24-7).

The combination of M=Cu and R═H for all positions is especially preferred. For instance, a compound of structure (5b) with M=Cu and R(5-20)=H is obtainable as Heliogen® Blue K 6911D or Heliogen® Blue K 7104 LW from BASF AG, Ludwigshafen.

Compounds of structure (5a) are available, for example, as Heliogen® Blue L 7460 from BASF AG, Ludwigshafen.

Further usable blue colorants include:

Colorants of formula (6) obtainable under the name “Macrolex Blue 3R Gran”

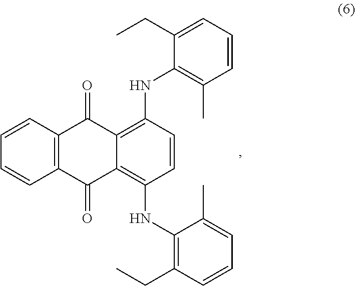 [SMILES: CCc1cccc(C)c1Nc1ccc(Nc2c(C)cccc2CC)c2c1C(=O)c1ccccc1C2=O]

and/or colorants of formula (7) obtainable under the name “Macrolex Blue RR” (CAS 32724-62-2; Solvent Blue 97; C.I. 615290),

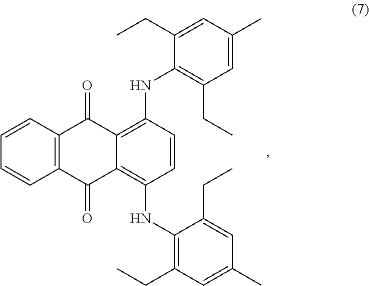 [SMILES: CCc1cc(C)cc(CC)c1Nc1ccc(Nc2c(CC)cc(C)cc2CC)c2c1C(=O)c1ccccc1C2=O]

A further usable blue colorant is:

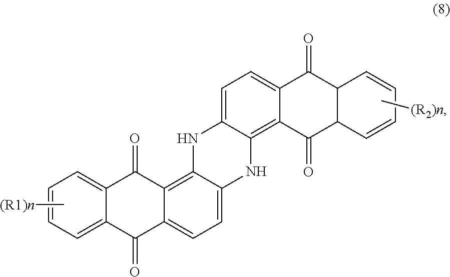

wherein
R1 and R2 independently of one another represent a linear or branched alkyl radical or halogen, preferably methyl, ethyl, propyl, isopropyl, butyl, isobutyl, tert-butyl, pentyl, neopentyl, hexyl, thexyl or Cl, more preferably methyl, Cl and particularly preferably Cl,
n represents a natural number between 0 and 4.

In a particularly preferred embodiment n=0 in all rings, and so all R1 and R2=H.

Colorants of this structure (8) are commercially available under the Paliogen Blue series from BASF AG.

When using colorants of structure (8) preference is given especially to pigments having a bulk volume (determined according to DIN ISO 787-11:1995-10) of 2 l/kg-10 l/kg, preferably 3 l/kg-8 l/kg, a specific surface area (determined according to DIN 66132:1975-07) of 5 m²/g-60 m²/g, preferably 10 m²/g-55 m²/g, and a pH (determined according to DIN ISO 787-9) of 4-9.

Preferably employed as the red colorant is a colorant of formula (9) obtainable under the name “Macrolex Red 5B” having CAS Number 81-39-0:

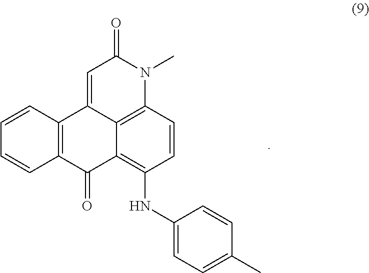 [SMILES: Cc1ccc(Nc2ccc3c4c(cc(=O)n3C)-c3ccccc3C(=O)c24)cc1]

Also employable are colorants of formulae (10) having CAS Number 20749-68-2 (also: 71902-17-5) and (11) having CAS Number 89106-94-5:

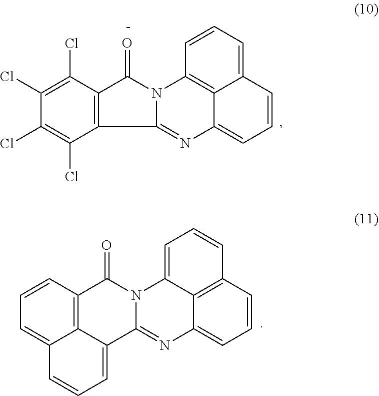 [SMILES: O=C1c2c(Cl)c(Cl)c(Cl)c(Cl)c2C2=Nc3cccc4cccc(c34)N12 ; O=c1c2cccc3cccc(c32)c2nc3cccc4cccc(c43)n12]

Preferably employed as violet colorants are colorants of formulae (12) having CAS Number 61951-89-1, (13) obtainable under the name “Macrolex Violet B” from Lanxess AG having CAS Number 81-48-1 or (14a/14b):

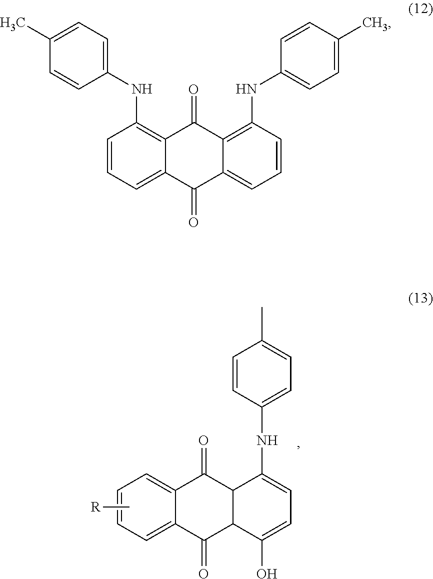

wherein R is selected from the group consisting of H and p-methylphenylamine radical; preferably R═H;

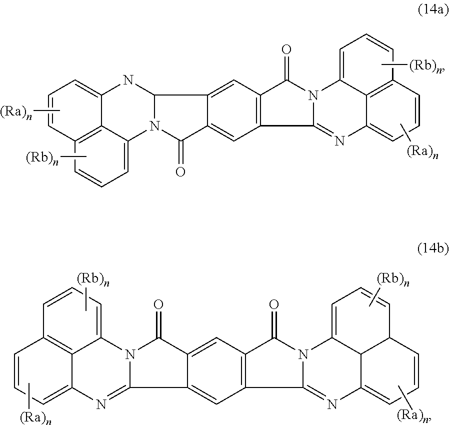

wherein
Ra and Rb independently of one another represent a linear or branched alkyl radical or halogen, preferably methyl, ethyl, propyl, isopropyl, butyl, isobutyl, tert-butyl, pentyl, neopentyl, hexyl, thexyl or Cl, more preferably methyl, Cl and particularly preferably Cl,
n independently of the respective R represents a natural number between 0 and 3, wherein the radical is hydrogen for n=0.

In a preferred embodiment Ra and/or Rb are Cl and are in o- and/or p-positions relative to the carbon atoms bearing the amine functionalities, for example di-orthochloronaphthalino, di-ortho, mono-para-chloronaphthalino and mono-ortho-naphthalino. Furthermore, in a preferred embodiment Ra and Rb each represent a tert-butyl radical which is preferably in the meta position relative to the carbon atoms bearing the nitrogen functionalities.

In a particularly preferred embodiment n=0 in all rings, and so all Ra and Rb=H.

Also employable are colorants conforming to formula (15) obtainable under the name “Macrolex RedViolet R”, CAS Number 6408-72-6:

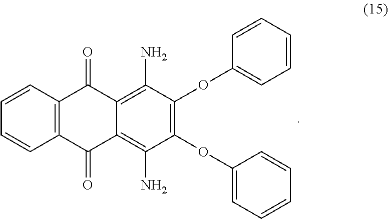 [SMILES: Nc1c(Oc2ccccc2)c(Oc2ccccc2)c(N)c2c1C(=O)c1ccccc1C2=O]

In a further embodiment the thermoplastic material comprises the following components:
at least 99% by weight based on the total weight of the material of aromatic polycarbonate having a melt volume rate MVR of 15 to 20 cm³/(10 min) determined according to ISO 1133-1:2012-03 (300° C., 1.2 kg);
colorants of formula (2a), (2b) and/or (2c);
colorants of formula (5b) where M=Cu and R(5-20)=H;
colorants of formula (10);
   wherein the sum of the altogether employed colorants is ≥0.017% by weight to ≤0.057% by weight based on the total weight of the material.

In a further embodiment the thermoplastic material comprises a yellow and/or orange colorant of formulae (16), (17), (18), (19), (20) or a mixture of at least two of these:

Employed as yellow colorants are colorants of formulae (16) obtainable under the name “Macrolex Yellow 3G” having CAS Number 4702-90-3 and/or (17) obtainable under the name “Macrolex Orange 3G” (CAS Number 6925-69-5, C.I. 564100):

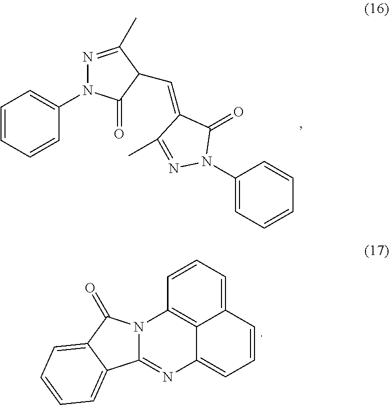 [SMILES: CC1=NN(c2ccccc2)C(=O)/C1=C/C1C(=O)N(c2ccccc2)N=C1C ; O=C1c2ccccc2C2=Nc3cccc4cccc(c34)N12]

It is further possible to use colorants of formulae (18) obtainable under the name “Oracet Yellow 180” having CAS number 13676-91-0, (19) having CAS number 30125-47-4 and/or (20) obtainable under the name “Oracet Orange 220; Solvent Orange 116” having CAS number 669005-94-1.

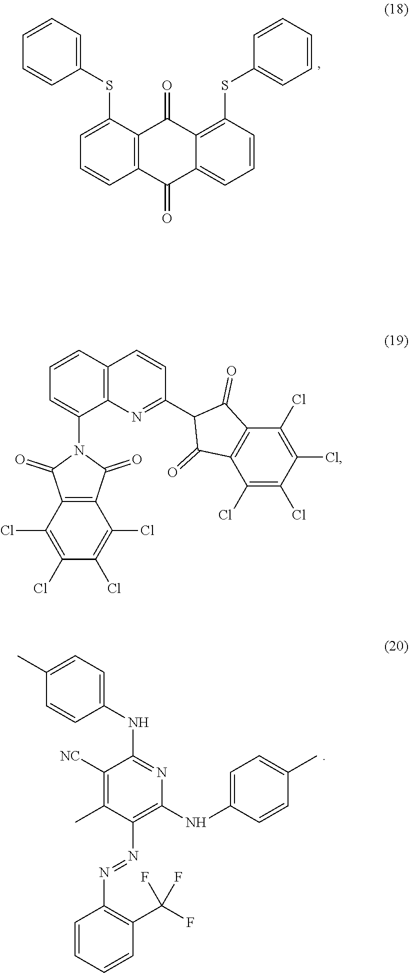

However, in principle further colorants may optionally also be employed in addition to the above-described colorants. Those preferred are Heliogen Green varieties (for example Heliogen Green K 8730; CAS 1328-53-6; Pigment Green 7; C.I. 74260).

Especially preferred are Green G (2a, b, c), Heliogen Green and Heliogen Blue (5a, 5b), Paliogen blue (8) in the one group and Macrolex Red EG (10) and Amaplast Violet PK (14a, 14b) and M. Violet B (13) in the other group in combination with yellow colorants.

Exemplary colorant combinations are reported below, wherein the % by weight values are based on the total weight of the thermoplastic material and may deviate by ±10% of the specified value:

Macrolex Violet 3R (12) and Macrolex Green 5B (1), in each case 0.1% by weight of each of these colorants;

Macrolex Red EG (10) 0.004% by weight, Macrolex Violet 3R (12) 0.001% by weight and Heliogen Blue K6911 [(5b) where M=Cu and R(5-20)=H] 0.0024% by weight;

Oracet Yellow 180 (18) 0.0004% by weight, Macrolex Red EG (10) 0.0045% by weight and Macrolex Green 5B (1) 0.0046% by weight;

Macrolex Red EG (10) 0.0007% by weight, colorants of structure (14a) and/or (14b) 0.0014% by weight and Paliogen Blue L6385 (8) 0.0030% by weight;

Colorants of structure (11) 0.0015% by weight, Macrolex Violet B (13) 0.0012% by weight and Heliogen Blue K6911 [(5b) where M=Cu and R(5-20)=H] 0.0010% by weight and 0.0018% by weight, Macrolex Blue RR (7) 0.0032% by weight and Macrolex Red EG (10) 0.0031% by weight.

In a further embodiment the cover further comprises a topcoat layer. This may be used to improve scratch and weathering resistance. Coating systems particularly suitable therefor and used for example for polycarbonate sheets in the construction sector, for headlight covers made of polycarbonate or else in the field of polycarbonate automotive glazing may be roughly divided into three categories:

(a) thermosetting coating systems based on a polysiloxane coating which may be either single-layer or multilayer systems (with a merely adhesion-promoting primer layer between the substrate and the polysiloxane topcoat). They are described inter alia in U.S. Pat. Nos. 4,278,804, 4,373,061, 4,410,594, 5,041,313 and EPA 1 087 001. One variant is the use of the adhesive primer necessary for the siloxane-based topcoat as a UV protection primer when said primer is mixed with a UV absorber and applied in a higher layer thickness.

(b) thermosetting multilayer systems comprising a UV protection primer and a topcoat based on a polysiloxane coating. Suitable systems are known for example from U.S. Pat. Nos. 5,391,795 and 5,679,820.

(c) UV-curable coating systems, based on acrylate, urethane acrylate or acrylosilane for example and optionally including fillers for improving scratch resistance, may likewise provide sufficient protection from weathering on account of their relatively broad application layer thickness window. Such systems are known and inter alia described in U.S. Pat. No. 3,707,397 or DE 69 71 7959, U.S. Pat. Nos. 5,990,188, 5,817,715, 5,712,325 and WO 2014/100300.

In a further embodiment the topcoat used in the topcoat layer is a UV-curable topcoat, such as has already been described under point c).

In a further embodiment the topcoat layer contains an organomodified silane or a reaction product thereof.

In a further embodiment an adhesion promoter layer (primer layer) is present between the topcoat layer and the thermoplastic material. Preference is given to a combination of an adhesion promoting UV protection primer based on polymethyl methacrylate comprising dibenzoyl resorcinol as a UV absorber and a polysiloxane topcoat comprising a silylated UV absorber. Both layers, i.e. the primer and the topcoat, together assume the UV protection function here.

In a further embodiment the cover further comprises: an anti-reflective layer, an anti-condensation layer, an anti-dust layer, a layer which improves media resistance, a layer which improves scratch resistance, or a combination thereof. Examples of anti-condensation and anti-dust layers are layers obtained by flame silicatization. Anti-reflection layers include all single-ply or multi-ply layer constructions having as their outer layer a layer of low refractive index (nD<1.5). Use of the coating used on the outside can also improve inter alia the properties of media resistance, scratch resistance, reflection reduction (antireflection) and a slight anti-dust effect.

The process for producing a system according to the invention comprises the steps of:
providing an at least partially injection-molded cover defined as specified hereinabove;
providing a LiDAR unit having an emitter for laser light having a wavelength of 800 nm to 1600 nm and a receiver for light having a wavelength of 800 nm to 1600 nm;
arranging the cover so that IR light emitted by the LiDAR unit and received thereby passes through the cover.

A further aspect of the invention is a vehicle comprising a system according to the invention. The system may be mounted not only on motor vehicles but also on other means of transport and means of locomotion, such as drones, aeroplanes, helicopters or rail vehicles, which in accordance with the invention are all subsumed within the term “vehicles”. Also included are (semi)autonomous machines which are not necessarily used for locomotion, such as robots, harvesters and the like.

The invention further relates to the use of a thermoplastic material for producing covers for LiDAR sensors and/or LiDAR receivers, wherein the thermoplastic material contains a transparent thermoplastic polymer and a monoester of a monocarboxylic acid having ≥10 carbon atoms and an alcohol having ≥3 carbon atoms and with the proviso that the thermoplastic material is free from mono-, di-, tri- and tetraesters of stearic acid with pentaerythritol and wherein the monoester is a monoester of a monocarboxylic acid having ≥15 carbon atoms and glycerol or a monoalcohol having ≥15 carbon atoms.

In one embodiment of the use the thermoplastic polymer is an aromatic polycarbonate. For avoidance of repetition, reference is made to the statements regarding the system according to the invention in respect of further embodiments and definitions. These are equally applicable to the use according to the invention.

### EXAMPLES

The present invention is more particularly elucidated hereinbelow with reference to the subsequent examples without, however, being limited thereto. The methods of determination described here are used for all corresponding variables in the present description of the invention unless otherwise stated.

### Components

PC-1: Linear bisphenol A homopolycarbonate comprising end groups based on phenol having a melt volume rate MVR of 19 cm³/10 min (measured at 300° C. and a loading of 1.2 kg according to ISO 1133-1:2011).

PC-2: Linear bisphenol A homopolycarbonate comprising end groups based on phenol having a melt volume rate MVR of 12 cm³/10 min (measured at 300° C. and a loading of 1.2 kg according to ISO 1133-1:2011).

PC-3: Linear bisphenol A homopolycarbonate comprising end groups based on phenol having a melt volume rate MVR of 6 cm³/10 min (measured at 300° C. and a loading of 1.2 kg according to ISO 1133-1:2011).

A: Pentaerythritol tetrastearate, CAS 115-83-3 (Glycolube P from Lonza GmbH Germany),

B: Glycerol monostearate, CAS 31566-31-1 (Dimodan Hab Veg from Danisco Deutschland GmbH, Germany),

C: 2-Octyldodecyl stearate, CAS 22766-82-1 (Loxiol 3820 from Emery Oleochemicals Europe, Düsseldorf, Germany),

D: Pentaerythritol distearate, CAS 13081-97-5 (Struktol VPEDS from Struktol Company of America; Ohio USA).

### Compounding

The compounding of the materials was carried out in a KraussMaffei Berstorff ZE25 twin-screw extruder at a barrel temperature of 260° C., a melt temperature of approx. 280° C. and a speed of 100 rpm. The additives A to D were mixed together with pulverulent polycarbonate PC-3 in the amounts specified below and then compounded together with the polycarbonates PC-1 or PC-2.

### Measurement of LiDAR Signal Strength

To reduce the scattered-light signals, the sensor head of the LiDAR sensor was shielded on the side away from the measurement path. Only lasers 1, 3, 5, 7, 8, 10, 12 and 14 were used. Furthermore, the field of view (FOV) of the sensor in the sensor interface was limited to 20° (350°-10°). The reflection surface used was a smooth white surface coated with TiO₂-containing paint. The wall was at a distance of 3.2 m from the LiDAR sensor.

The test specimens were tested using a sample holder parallel to the LiDAR, wherein the back side of the sample was arranged about 15 mm in front of the LiDAR sensor so that both the output signal and the reflected input signal had to pass through the wall thickness of the test sheet. Evaluation was performed using “VeloView” software from Velodyne, the manufacturer of the LiDAR sensor. The average value of the intensities measured for a sample was determined. This average sample value was divided by the average value of the reference measurement (air) to determine the relative intensity.

The measured intensities of the re-recorded laser signal were between 0% and 100%. The lower the attenuation (weakening) of the signal, i.e. the higher the intensity of the signal measured, the more suitable the cover for LiDAR-assisted sensor applications in the automotive sector. The intensities measured in the examples are documented in the column “LiDAR signal based on air value in %”.

### Measurement of Static Friction

The coefficients of friction were determined using a modified Arburg-370S-800-150 injection molding machine. The method is described in EP 1 377 812 B1. Static friction is the coefficient of friction that is derived from the force required to set objects at rest relative to one another (piston/test specimen) in motion (threshold value).

The coefficient of static friction is defined as follows: F_{R}=μ×F_{N} or, rearranged for μ, μ=F_{R}/F_{N} (F_{N}=normal force, F_{R}=frictional force, μ=coefficient of friction).

In the case of circular motion the following relationship applies: F_{R}=M_{d}/rₘ (M_{d}=torque, rₘ=average radius of the friction surface (ring surface)) and M_{d}/rₘ=μ×F_{N} and, rearranging for μ, μ=M_{d}/(rₘ×F_{N}).

A disk-shaped test specimen having an outer diameter of 92 mm and a thickness of 2.6 mm was produced in a coefficient of friction mold. Said specimen had at its outer edge a 5 mm high and 3 mm wide strip on which were arranged shallow depressions, comparable to a toothed belt pulley, by means of which the torque is transferred from the mold to the test specimen.

This allows direct determination of the coefficient of static friction using a disk-shaped test specimen immediately after solidification thereof. In this case, the frictional force is proportional to the torque. Upon opening of the mold a piston connected to a torque sensor pushes against the molded part (friction partner) with a defined normal force F_{N}. On the other side of the molded part the test specimen is held and set in rotation. The torque measured at the piston is used to determine the coefficient of static friction between the piston and the test specimen. Since the friction is caused by the unevenness of the surfaces sliding against one another (snagging) the piston was configured to have an average surface roughness Ra=0.05 μM.

In an injection molding machine the materials were melted and at a melt temperature of 280° C. injected into the closed coefficient of friction mold at a mold wall temperature of 80° C. and held for 15 s at a holding pressure of 550 bar. After a residual cooling time of 20 s the mold was opened slightly and the coefficients of static and sliding friction were determined.

The results are shown in the table below. Examples marked “V” are comparative examples and examples marked “E” are inventive.

| | 1V | 2V | 3V | 4E | 5E | 6E | 7E | 8V | 9V | 10V | 11E |
|---|---|---|---|---|---|---|---|---|---|---|---|
| Composition | | | | | | | | | | | |
| [% by weight] | | | | | | | | | | | |
| PC-1 | 95 | 95 | 95 | 95 | 95 | 95 | 95 | 95 | 95 | | |
| PC-2 | | | | | | | | | | 95 | 95 |
| PC-3 | 4.8 | 4.7 | 4.6 | 4.98 | 4.96 | 4.85 | 4.7 | 4.97 | 4.96 | 4.6 | 4.96 |
| A | 0.2 | 0.3 | 0.4 | | | | | | | 0.4 | |
| B | | | | 0.02 | 0.04 | | | | | | 0.04 |
| C | | | | | | 0.15 | 0.3 | | | | |
| D | | | | | | | | 0.03 | 0.04 | | |
| Results | | | | | | | | | | | |
| LiDAR signal | 78.7 | 78.4 | 73.7 | 80.8 | 80.2 | 82.6 | 80.7 | 81.9 | 82.6 | 78.4 | 80.4 |
| strength [%] | | | | | | | | | | | |
| Coefficient of | 0.32 | 0.29 | 0.27 | 0.37 | 0.33 | 0.29 | 0.25 | 0.44 | 0.43 | 0.27 | 0.27 |
| static friction | | | | | | | | | | | |
| Coefficient of | 0.35 | 0.33 | 0.30 | 0.37 | 0.34 | 0.31 | 0.25 | 0.44 | 0.43 | 0.30 | 0.27 |
| sliding friction | | | | | | | | | | | |

It is apparent that only the inventive compositions simultaneously achieve a high residual signal strength and the required demolding effect, represented as coefficients of sliding and static friction. Compositions with other demolding agents did not exhibits the desired combination of properties.

1.-15. (canceled)

16. A sensor system comprising
a LiDAR unit having an emitter for laser light having a wavelength of 800 nm to 1600 nm and a receiver for light having a wavelength of 800 nm to 1600 nm;
a cover arranged such that IR light emitted by the LiDAR unit and received thereby passes through the cover,
wherein
the cover comprises a layer of a thermoplastic material, wherein the thermoplastic material contains a transparent thermoplastic polymer and a monoester of a monocarboxylic acid having ≥10 carbon atoms and an alcohol having ≥3 carbon atoms, wherein the monoester is a monoester of a monocarboxylic acid having ≥15 carbon atoms and glycerol or a monoalcohol having ≥15 carbon atoms,
with the proviso that the thermoplastic material is free from mono-, di-, tri- and tetraesters of stearic acid and pentaerythritol.

17. The system as claimed in claim 16, wherein the monoester is a monoester of a monocarboxylic acid having 15 to 20 carbon atoms.

18. The system as claimed in claim 16, wherein the monoester is present in a proportion of ≥0.01% by weight to ≤0.6% by weight based on the total weight of the thermoplastic material.

19. The system as claimed in claim 16, wherein the transparent thermoplastic polymer is an aromatic polycarbonate.

20. The system as claimed in claim 16, wherein the cover attenuates the LiDAR signal only to the extent that the signal intensity of IR light emitted by the LiDAR unit and re-received thereby (determined by reflection from a smooth surface painted with TiO₂-containing white paint at a distance of 3.2 m) is ≥80% of a reference intensity determined without the cover.

21. The system as claimed in claim 16, wherein the thermoplastic material has a coefficient of static friction, determined as described in EP 1 377 812 B1, of ≤0.37.

22. The system as claimed in claim 16, further comprising a camera for visible light having a wavelength of 380 nm to 780 nm, wherein visible light received by the camera passes through the cover.

23. The system as claimed in claim 16, wherein the cover further comprises a layer containing dyes and/or the thermoplastic material contains colorants, so that the cover has a light transmission Ty in the range from 380 to 780 nm of ≥3% to ≤25% determined according to DIN ISO 13468-2:2006 (D65, 10°) and the colorants are at least one green and/or one blue colorant and at least one red and/or violet colorant.

24. The system as claimed in claim 16, wherein the cover further comprises a topcoat layer.

25. The system as claimed in claim 24, wherein an adhesion promoter layer is present between the topcoat layer and the thermoplastic material.

26. The system as claimed in claim 16, wherein the thermoplastic material of the layer described in claim 16 contains only aromatic polycarbonate as the transparent thermoplastic polymer and no further monoesters of monocarboxylic acids other than those mentioned.

27. A process for producing a system as claimed in claim 16, comprising the steps of:
providing an at least partially injection-molded cover as defined in claim 16;
providing a LiDAR unit having an emitter for laser light having a wavelength of 800 nm to 1600 nm and a receiver for light having a wavelength of 800 nm to 1600 nm;
arranging the cover so that IR light emitted by the LiDAR unit and received thereby passes through the cover.

28. A vehicle comprising a system as claimed in claim 16.

29. A method comprising providing a thermoplastic material and producing covers for LiDAR sensors and/or LiDAR receivers,
wherein
the thermoplastic material contains a transparent thermoplastic polymer and a monoester of a monocarboxylic acid having ≥10 carbon atoms and an alcohol having ≥3 carbon atoms,
with the proviso that the thermoplastic material is free from mono-, di-, tri- and tetraesters of stearic acid and pentaerythritol and wherein the monoester is a monoester of a monocarboxylic acid having ≥15 carbon atoms and glycerol or a monoalcohol having ≥15 carbon atoms.

30. The method as claimed in claim 29, wherein the transparent thermoplastic polymer is an aromatic polycarbonate.
